(19) United States
(12) Patent Application Publication
(10) Pub. No.: US 2014/0371925 A1
(43) Pub. Date: Dec. 18, 2014

(54) Cloud Connected Intelligent Heater/Chiller System

(71) Applicant: Andrew Butler, Palo Alto, CA (US)

(72) Inventor: Andrew Butler, Palo Alto, CA (US)

(21) Appl. No.: 14/308,640

(22) Filed: Jun. 18, 2014

Related U.S. Application Data
(60) Provisional application No. 61/836,639, filed on Jun. 18, 2013.

(51) Int. Cl. F25B 30/00; H04L 12/28; G05D 27/02

(52) U.S. Cl. CPC F25B 30/00; G05D 27/02; H04L 12/2816
USPC 700/282

(57) ABSTRACT

An intelligent, cloud-connected heater/chiller device for water that uses a heat pump to provide heated or chilled water, is programmable by the user to set the temperature levels of the water and the desired usage times, and can also provide carbonated and filtered water.

### FIELD OF THE INVENTION

The present invention relates generally to water heaters and chillers, and more particularly to smart water heaters and chillers that can connect to the cloud.

### BACKGROUND

There is much consumer demand for water systems that provide chilled drinking water, instant hot water, carbonated water, or filtered water. Currently, a consumer would need to acquire a separate device to provide each one of these types of water—a compressor system or a refrigerator water dispenser for instant chilled water, a water heating device for instant hot water, a countertop carbonation device for carbonated water, and a separate filtration system for filtered water. This is cumbersome and expensive.

Also, conventional heating or chilling systems use a lot of energy. Chilled water systems typically use a conventional compressor-based refrigerant to extract heat from the water and to dissipate waste heat to the ambient air. Water heating systems typically use resistive elements to directly transfer heat from electric energy. Because the two systems are separate, a lot of energy is wasted.

A need therefore exists for a compact system that can provide filtered water in all of the above conditions and that can be customized and reprogrammed by the user, and for a system that uses less energy to do so.

### SUMMARY OF THE INVENTION

An object of the present invention is to provide a more efficient water system that uses a heat pump to provide hot or cold water.

Another object of the present invention is to provide an intelligent water system that provides water at a desired temperature in a desired amount when needed, and shuts off when not needed.

Another object of the present invention is to provide an intelligent water system that anticipates a user's need for water and provides water at a desired temperature in a desired amount to meet the anticipated need.

The system of the present invention comprises a heat pump capable of heating or cooling the water provided by a household plumbing system, a controller capable of controlling the heat pump, and at least one reservoir tank for storing predetermined amounts of water at a given temperature (in the preferred embodiment, there are three water tanks that store water at three different temperatures). The controller comprises a communication module that can communicate wirelessly with a smartphone or other mobile device. The mobile device is used to interact with the controller (preferably through an app) and to trigger it to provide desired amounts of water at a desired temperature or to go to sleep to save energy.

The user may enter water usage needs into the mobile device directly, or the controller can record past water usage data and use it to predict future water usage needs. The mobile device may also be used to receive external data that affects water usage needs. For example, the mobile device may receive weather data from the Internet and use the weather data to predict future water need. The mobile device may receive data from other smart devices in the home and trigger the controller to turn off when no one is home, to provide more cold water when a smart thermostat is set to a colder temperature, and so on. The mobile device may also receive data from other apps on the mobile device itself, such as a fitness app that tells it when a user has just completed a workout (and therefore needs to drink some water and take a shower), or a GPS app that tells it when a user is not at home.

In an embodiment, the system of the present invention also comprises a carbonation device that can carbonate the water on demand.

The controller can also serve other functions, such as a data relay device in a mesh network, to assist in the function of other smart devices in the home.

### LIST OF FIGURES

FIG. 1 shows a graph of the energy savings of the system of the present invention over a conventional heater/chiller system.

FIG. 2 shows a diagram of the preferred embodiment of the present invention.

### DETAILED DESCRIPTION OF THE PREFERRED EMBODIMENT

An object of the present invention is to provide a device that can supply instant hot water, instant chilled water, or carbonated water and that can filter the water as well.

Another object of the present invention is to provide a device that uses less energy and takes up less space that conventional water heaters or chillers.

Another object of the present invention is to provide a device that supplies instant hot water, instant chilled water, or carbonated water at temperatures and degrees of carbonation that can be customized by the user.

The preferred embodiment of the present invention comprises a thermo-electric heat pump for both heating and cooling the water. The advantages of a thermo-electric heat pump are that it is far more compact than conventional heaters or chillers. Also, because the heating and chilling functions are provided by one device—the heat pump—it can use the waste heat from the cooling cycle to heat the water. This results in significant energy savings. Finally, a thermo-electric heat pump is quiet and produces minimal vibrations.

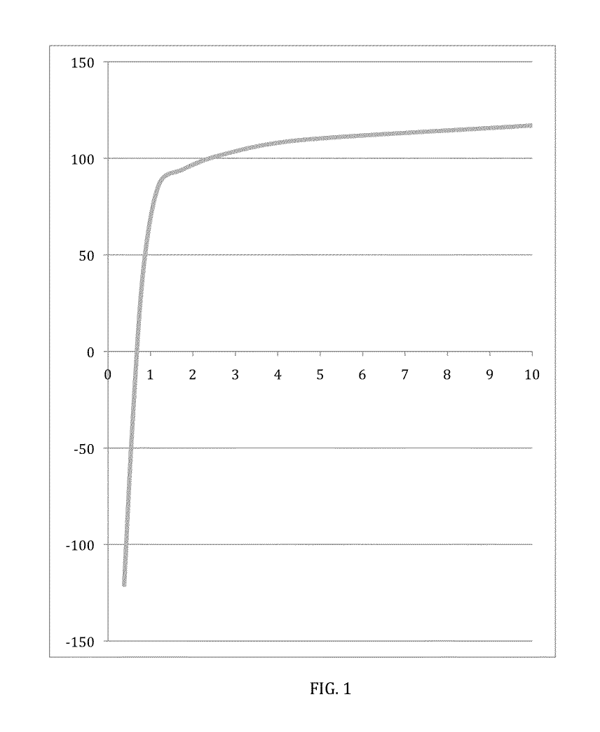

FIG. 1 shows the relative wattage savings of a heat pump system compared to a combination of compressor (for cooling) and resistive heater. The x-axis is the ratio of hot water to cold water used, while the y-axis is the wattage savings (positive numbers) or losses (negative numbers). As can be seen from the graph, the energy savings are significant when the ratio of hot water to cold water is 1 or more.

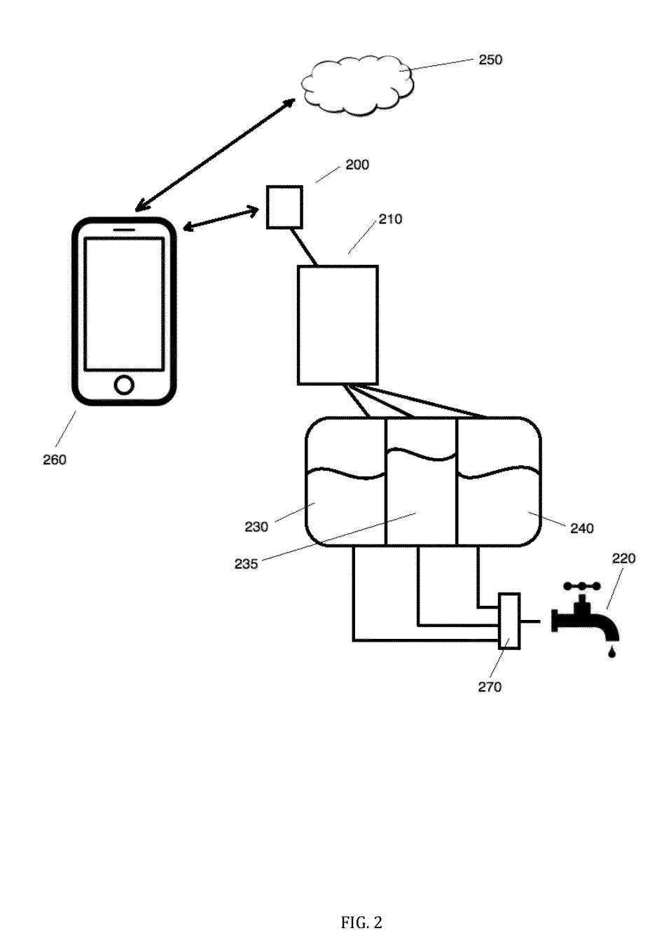

FIG. 2 shows a diagram of the system of the present invention. The intelligent heat pump of the preferred embodiment provides either cold or hot water, depending on user needs; the water may also be carbonated as the user desires. In the preferred embodiment, the intelligent heat pump of the present invention comprises a heat pump 210 and a controller 200. The controller 200 preferably comprises a communications interface with the heat pump that can trigger it to heat or cool the water as needed; a communications interface with a smartphone or other mobile device to enable a user to interact with the system; a processor and memory sufficient to carry out these communication tasks, as well as the other tasks described below; an interface to at least one thermometer or other temperature measurement device, to provide feedback on the water temperature; and an interface to a carbonation module so that the user can control water carbonation. The communications interfaces described above may be wireless or wired, and if wireless, may use any commonly used wireless protocol, such as wi-fi, Bluetooth, 3G, 4G, and so on.

The heat pump 210 is preferably any standard heat pump water heater commonly used in industry, as long as the heat pump water heater is capable of interacting with a controller as described above, and capable of handling the volumes of hot and cold water required for standard residential use.

Reservoir tanks 230, 235, and 240 can store sufficient quantities of hot or cold water for that purpose. In the preferred embodiment, three reservoir tanks are used, at a size of 2 liters each—one for hot water, one for cold water, and one for custom-temperature water or as additional capacity for either the hot or cold reservoirs thus allowing the user to customize their system according to their predominant usage patterns. For example, the user may wish to have one tank for warm water for bathing or showering, and one tank for boiling-hot water for coffee or tea. The tanks are preferably well-insulated to avoid heat loss. While three water tanks are used in the preferred embodiment, other embodiments may use two (hot and cold) or only one (hot) to save cost and space. In an embodiment, the tanks may also comprise water filters at the inlet or outlet to improve the quality of the water.

Carbonation device 270 is preferably connected to the outputs of all water tanks so that the system can deliver carbonated water at any temperature if desired. In an alternate embodiment (not shown), carbonation device 270 may only be connected to the cold water tank, or simply to the cold water pipe if no cold water tank is used.

In the preferred embodiment, thermometers are located in each water tank. The thermometers provide feedback to the controller about the temperature of the water in each tank. The controller 200 can then trigger the heat pump to heat or cool the water in each tank as needed. The user can interact with the controller 200 to set the temperature for each tank.

The controller 200 can predict and anticipate the user's water needs. For example, the system can anticipate that the user makes tea at 6 am every weekday, and make sufficient hot water at the right temperature available for that use in advance of the event; then, the system can go to sleep at 9 am while the user is at work, and wake up at in advance of the user's return at 5 pm to provide enough hot and chilled water for the user's needs when the user comes home from work. The energy savings of a heat pump system over a conventional resistive heater and compressor for this usage is around 15%-20%.

The system can “learn” the user's water usage patterns; for example, if the user always makes tea at 6 am every weekday but on weekends drinks tea at 10 am, the system can learn this pattern resulting in greater energy efficiency and user convenience. The system may also be programmable by the user directly; for example, the user can program into the system how much hot water and cold water they require at any given time and when they're likely to be out of the house. The system may use a combination of learning the user's behavior by tracking water demand and direct data entry by the user in order to provide the optimal amounts of water at the right time.

The user can communicate with the controller by a smartphone, a computer, or any other device 260. A smartphone is shown in the Figure, though this is not meant to limit the disclosure to that device; the usage of the word “smartphone” in the patent application is meant to include other mobile devices, computers, iPads and tablets, or any other device that can send wireless signals over the Internet.

In an embodiment, several smartphones may be used by different users to communicate with the controller. The controller may be programmed to respond to whichever smartphone is closer to the controller, whichever user requires more water, or whichever user is set as the preferred user whose preferences “trump” the other user.

In the preferred embodiment, the smartphone 260 comprises an app that can be used to communicate with the controller 200. The app preferably comprises modules that can be used to set the water temperature in each tank, the amount of water desired at each temperature at any given time, the times the user is out of the house, and so on. In an embodiment, the app uses user input via the smartphone to set those parameters. In another embodiment, the app uses other external data in addition to user input (or instead of user input) to set those parameters. For example, the app may communicate with the Internet to get weather data, and increase the amount of cold water in the cold water storage tank on a hot day. The app may learn that the user always drinks a lot of tea on Saturdays and increase the amount of hot water in the hot water storage tank.

The app may also communicate with other smart devices in the home to learn about the user's location, activity, and anticipated water needs. For example, the app may communicate with a smart thermostat to learn whether or not the user is at home, what room the user is in, and what temperature is set in the house. The app may then use the data to turn off the heat pump when the user is not at home, to turn on the heat pump and provide enough hot water when the user enters the bathroom in the morning, to provide enough boiling-hot water when the user enters the kitchen, and to provide more or less hot water depending on the temperature of the house (i.e. more hot water when the temperature is set to a higher amount, more cold water when the temperature is set to a lower amount). Other smart devices may also provide information to the app regarding the user's activities, location, and anticipated water needs.

The app may also communicate with other apps on the smartphone itself to learn more about the user's activities and anticipate the user's water needs. For example, if the GPS of the smartphone shows that the user is not at home, the app may trigger the controller to go to sleep to avoid wasted energy. If the user has a fitness-related app on the smartphone and the fitness-related app shows that the user has just worked out and is now at home, the app can trigger the controller to provide more cold water.

In the preferred embodiment, the controller tracks the user's water usage on a weekly basis and establishes usage patterns that can then be used to predict future usage. For example, the controller may record that the user uses a lot of hot water every weekday morning at 6 am to take a shower and to make coffee, but on weekends, uses a lot of hot water at 10 am for that purpose. Since most people's lives are structured around a weekly cycle, it makes sense to track the data by the week and to make conclusions based on a weekly cycle. However, other patterns may also be used in other embodiments. The data recorded by the controller may comprise the timing and duration of water use, the temperature of the water used, the amount of water used, the location of water use (i.e. kitchen or bathroom), and any other data that is relevant to water usage. The data is then stored in memory and processed by the processor to make intelligent conclusions about future water use. In the preferred embodiment, the data and any predictions are communicated to the smartphone via the app.

The app can allow the user to manually override the automatic on/off cycles of the controller—for example, if the user is working from home one day, they may not want the system to go to sleep at 9 am, and they may want more hot water to use throughout the day for making coffee. The user may also cause the system to go into “vacation mode” so that no energy is wasted while the house is empty.

In an embodiment, the system can also provide carbonated water by means of a standard carbonation device built into the system. The carbonation device is preferably connected to the chilled water tank, so that the carbonated water is chilled. The user may control the carbonation levels by the smartphone. The smartphone may also be able to alert the user when the carbonator needs to be replaced.

In an embodiment, the system can also include a filter that is connected upstream of the heat pump, or at any other point within the system. The filter may be any standard water filter known in the art. In the preferred embodiment, the user may also be able to use the app on their smartphone to communicate with the water filter, may be able to customize the filtering (for example, to filter the water more when the municipality issues a boil-water alert, or to harden or soften the water), and the app may alert the user when the filter needs to be replaced.

Since the system preferably provides hot water at a very high temperature sufficient for making coffee or tea (preferably 90° C.), a child safety feature may be included in some embodiments. In those embodiments, the system may include a special interlock for the hot water switch that a child may not be able to operate, a fingerprint or face recognition system that distinguishes an adult from a child, or other childproofing devices known in the art.

In an embodiment, the controller may also serve other functions. For example, it may serve as a field relay in a mesh network to improve connectivity for other devices. It may also control other smart appliances.

Exemplary embodiments have been described above. Other embodiments are apparent to one of reasonable skill in the art, and the invention is not meant to be limited to the exemplary embodiments described above, but only to the limits set in the appended claims.

1. A system for providing household water, comprising:
a heat pump, said heat pump capable of heating or cooling water provided by a household plumbing system;
a controller for controlling the heat pump;
at least one reservoir tank connected to the household water system downstream of the heat pump and connected to at least one water tap;
a temperature measuring device in the at least one reservoir tank connected to the controller;
a communication module connected to the controller, said communication module capable of communicating with a mobile device;
at least one mobile device capable of communicating with the communication module and with the Internet, said mobile device configured to trigger the controller to activate the heat pump to fill the at least one reservoir tank with a first quantity of water at a first temperature at a first time; to trigger the controller to activate the heat pump to fill the at least one reservoir tank with a second quantity of water at a second temperature at a second time; and to trigger the controller to deactivate the heat pump at a third time.

2. The system of claim 1, wherein the controller records water usage data.

3. The system of claim 2, wherein the mobile device communicates with the controller to receive water usage data, and uses the water usage data to trigger the controller in such a way as to anticipate future water usage.

4. The system of claim 1, wherein a user can enter anticipated water usage data into the mobile device, and wherein the mobile device communicates this data to the controller.

5. The system of claim 1, comprising a first water tank to be used for storing water at a first temperature, a second water tank to be used for storing water at a second temperature, and a third water tank to be used for storing water at a third temperature.

6. The system of claim 5, wherein a user can preset the first temperature, second temperature, and third temperature via the mobile device.

7. The system of claim 1, wherein the mobile device receives external data that it communicates to the controller, and wherein the controller uses the data to set at least one of temperature, timing, and amount of water usage.

8. The system of claim 7, wherein the external data relates to weather.

9. The system of claim 7, wherein the external data relates to the location of the mobile device.

10. The system of claim 7, wherein the external data is provided by other apps on the mobile device.

11. The system of claim 1, further comprising a carbonation device.

12. The system of claim 1, further comprising a child-safety device, said child-safety device capable of preventing a young child from accessing very hot water.

13. The system of claim 12, wherein the child-safety device is one of the following group: a safety interlock that a young child cannot operate, a biometric device that distinguishes between adults and children.

14. A method of providing water, comprising:
sending information regarding water usage patterns from a mobile device to a controller;
using the controller to trigger a heat pump to provide a first amount of water at a first temperature at a first time;
using the controller to trigger a heat pump to provide a second amount of water at a second temperature at a second time;
storing the first amount of water in a first water tank;
storing the second amount of water in a second water tank;
providing the water to a user through a water tap connected to the first water tank and the second water tank.

15. The method of claim 14, wherein the information comprises past usage patterns.

16. The method of claim 14, further comprising sending information regarding water usage patterns from the controller to the mobile device.

17. The method of claim 14, wherein the information comprises times when a user is not at home.

18. The method of claim 14, wherein the information comprises weather data.

19. The method of claim 14, wherein the information comprises the location of the mobile device.

20. The method of claim 14, wherein the information comprises data received from other apps on the mobile device.

21. The method of claim 14, wherein the information comprises water usage preferences set by a user.

22. The method of claim 14, further comprising carbonating the water.

23. The method of claim 14, wherein the information comprises weather data received from the Internet.

24. The method of claim 14, wherein the information comprises data from other devices in the home.

25. The method of claim 14, wherein the controller also serves as a data relay device in a mesh network.
